(19) United States
(12) Patent Application Publication
(10) Pub. No.: US 2023/0369640 A1
(43) Pub. Date: Nov. 16, 2023

(54) Active-Metal Cells Having Composite Layers for Controlling Dendrite Growth

(71) Applicant: SES Holdings Pte. Ltd., Singapore (SG)

(72) Inventors: Arunkumar Tiruvannamalai, Andover, MA (US); Yongkyu Son, Bedford, MA (US)

(21) Appl. No.: 18/246,424

(22) PCT Filed: Sep. 23, 2021
(86) PCT No.: PCT/IB2021/058703

§ 371 Date: Mar. 23, 2023

Related U.S. Application Data
(60) Provisional application No. 63/198,050, filed on Sep. 25, 2020.

(51) Int. Cl. H01M 10/056; H01M 10/052; H01M 4/134; H01M 4/38

(52) U.S. Cl. CPC H01M 10/056; H01M 10/052; H01M 4/134; H01M 4/382; H01M 2004/027

(57) ABSTRACT

Composite layers for controlling dendrite growth in electrochemical cells having active-metal anodes prone to dendrite growth during cycling. In some embodiments, one of the composite layers includes a porous matrix having pores, solid electrolyte particles, and one or more alloying materials that alloy with the active metal so that each dendrite that contacts the alloying material alloys with it to prevent that dendrite from growing beyond the composite layer. In some embodiments, another of the composite layers includes a gel electrolyte and solid electrolyte particles dispersed in the gel electrolyte. Each of these two types of composite layers can be deployed in an electrochemical cell separately from one another or together with one another, with the gel-electrolyte composite layer typically being deployed in contact with an active-metal anode and the porous composite layer typically being deployed between an active-metal anode and a separator.

### RELATED APPLICATION DATA

This application claims the benefit of priority of U.S. Provisional Patent Application Ser. No. 63/198,050, filed Sep. 25, 2020, and titled “COMPOSITE LAYERS FOR DENDRITIC ACTIVE-METAL PREVENTION AND ENTRAPMENT”, which is incorporated by reference herein in its entirety.

### FIELD OF THE INVENTION

The present invention generally relates to the field of active-metal electrochemical cells. In particular, the present invention is directed to active-metal cells having composite layers for controlling dendrite growth.

### BACKGROUND

Rechargeable lithium-metal cells offer higher volumetric and gravimetric energy density than conventional lithium-ion batteries. Unlike lithium-ion cells, which contain anodes formed from an intercalant material such as graphite, lithium-metal-cell anodes are made of metallic lithium, for example, thin sheets of lithium foil laminated onto a current-collector. Lithium is electro-deposited onto the anode during charging and is stripped from the anode during discharging of a lithium-metal cell.

In comparison to dense lithium metal, lithium electro-deposited on the anode during charging of a liquid-electrolyte-based cell exhibits a “dendritic,” or “mossy,” morphology having high porosity and high surface area. This is due to uneven current distribution at the lithium-electrolyte interface caused by the formation of a passivation layer, or solid electrolyte interface (SEI) layer, between the anode and the liquid electrolyte on contact.

The high surface area of the electro-deposited lithium on the anode and the repeated SEI layer formation on cycling consumes both lithium and electrolyte, leading to lithium loss and drying-up of the electrolyte. Lithium loss decreases the coulombic efficiency and cycle life of the cell, and electrolyte loss increases the internal resistance of the cell. In extreme conditions, lithium dendrites formed on the anode surface penetrate the separator and make electrical contact with the cathode, causing an internal short circuit within the cell. Cell shorting by dendrites may lead to dramatic failure, accompanied by fire and explosion.

Most approaches to dendrite mitigation focus on improving the stability and uniformity of the SEI layer on the lithium surface by optimizing electrolyte components such as lithium salts, solvents, and additives. However, since the SEI layer is essentially made of reaction products between lithium and the electrolyte (the majority of which is a mixture of various lithium salts), it is very difficult to achieve a thin, uniform, and stable passivation layer with existing liquid electrolytes. Alternatively, solid-state electrolytes with high shear moduli, such as a Li+ (lithium ion) conducting polymer, glass, or ceramic material, have been explored before to act as mechanical barriers to block dendrite penetration. However, solid-state electrolytes have limited kinetic properties, such as low Li+ conductivity at room temperature and high interfacial resistance and are therefore not suitable for practical applications.

### SUMMARY OF THE DISCLOSURE

In one implementation, the present disclosure is directed to an electrochemical cell that includes an active-metal anode that includes a current collector and an active metal electrically coupled to the current collector; a cathode located in operative relation to the active-metal anode; a separator located between the active-metal anode and the cathode; a non-solid electrolyte in operative ionic contact with the cathode and permeating the separator; a first composite layer located between the active-metal anode and the separator and comprising a porous matrix that is porous to the non-solid electrolyte and includes pores; first solid-electrolyte particles dispersed in the porous matrix, wherein the first solid-electrolyte particles are provided to conduct ions of the active metal during operation of the electrochemical cell; and alloying particles located in the pores of the porous matrix, wherein the alloying particles are particles selected for ability to alloy spontaneously with the active metal and deployed to inhibit dendrite growth through the first composite layer by alloying with dendrites that encounter the first composite layer.

In another implementation, the present disclosure is directed to an electrochemical cell that includes an active-metal anode that includes a current collector and an active metal electrically coupled to the current collector; a cathode located in operative relation to the active-metal anode; a non-solid electrolyte in operative ionic contact with the cathode; a composite layer located between the active metal of the active-metal anode and the non-solid electrolyte, wherein the composite layer is provided to inhibit dendrite growth on the active-metal anode and to function as an active-metal-ion conductor between the active metal and the non-solid electrolyte and comprises a polymer gel electrolyte containing at least one polymer and a liquid electrolyte; and solid-electrolyte particles dispersed in the polymer gel electrolyte, wherein the solid-electrolyte particles are provided to conduct ions of the active metal during operation of the electrochemical cell.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A is a schematic cross-sectional view illustrating internal components of an example active-metal electrochemical cell of the present disclosure;

FIG. 1B is a front view of an example secondary battery cell that contains the internal components of FIG. 1A, wherein the example secondary battery cell is of the pouch type;

FIG. 2 is a flow diagram illustrating example methods of preparing first and second composite layers of the present disclosure, such as the first and second composite layers of FIG. 1A; and

FIG. 3 is graph of cycle life performance of a pair of test cells, with one of the test cells including an instantiation of the second composite layer of FIG. 1A, and the other test cell does not include the second composite layer.

### DETAILED DESCRIPTION

In some aspects, the present disclosure is directed to active-metal electrochemical cells, such as secondary battery cells and ultracapacitor cells, that contain liquid electrolyte and/or gel electrolyte (i.e., “non-solid electrolyte”) and include one or more uniquely composed composite layers designed and configured to control growth of dendrites during cycling of the cells. In the context of the present disclosure and accompanying claims, the term “active-metal” indicates that the anode of the corresponding cell is of the non-intercalating type and comprises a metal, in either a single-element form or an alloy form, that provides the active material of the anode and is prone to forming dendrites and/or mossy metal during cycling of the cell. Examples of active-metals include lithium, lithium-containing alloys, sodium, sodium-containing alloys, potassium, potassium-containing alloys, other alkali metals and alkali-containing metals, aluminum, aluminum-containing alloys, zinc, and zinc-containing alloys, among others. As mentioned in the Background section above, it is important to suppress dendrite growth so that no dendrite grows so much that it penetrates through the separator and reaches the cathode. This suppression not only can prevent the cell from internally short-circuiting and causing the cell to fail and even explode violently, but it can also improve the performance and cycle life of the active-metal cell.

It is noted that throughout the present disclosure and the appended claims, the term “about” when used with a corresponding numeric value refers to ±20% of the numeric value, typically ±10% of the numeric value, often ±5% of the numeric value, and most often ±2% of the numeric value. In some embodiments, the term “about” can mean the numeric value itself.

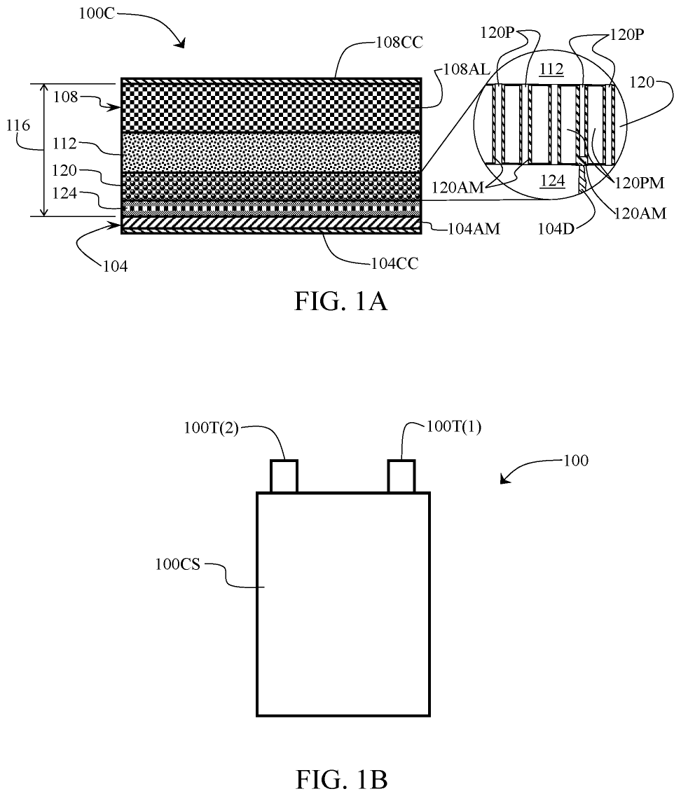

Referring now to the drawings, FIG. 1A illustrates internal components 100C of an example active-metal electrochemical cell, or more simply “active-metal cell”, made in accordance with the present disclosure. The active-metal cell may be any type of electrochemical cell, such as a secondary-battery cell 100 (FIG. 1B) or an ultracapacitor cell (not shown). Those skilled in the art will readily understand that a complete active-metal cell will include more components than illustrated in FIG. 1A, including a containment structure 100CS (e.g., a flexible pouch or cylindrical casing) and electrical tabs 100T(1) and 100T(2) shown in FIG. 1B, among others, as they are unnecessary to an understanding of the disclosed dendrite-growth-suppression features. Indeed, those skilled in the art will readily know the other components of an active-metal cell, such that they need not be described or listed herein for those skilled in the art to practice the dendrite-growth-suppression features of the present disclosure to their fullest scope without undue experimentation. Those skilled in the art will also understand that FIG. 1A illustrates only one anode-cathode pair. This is done for simplicity, as an actual active-metal cell may include multiple anode-cathode pairs stacked with one another. In addition, those skilled in the art will appreciate that one or more additional layers, such as a thermal-runaway-prevention layer, SEI layers, etc., may be included in an active-metal cell made in accordance with the present disclosure.

In this example, the internal components (collectively indicated at 100) of the active-metal cell include an active-metal anode 104, a cathode 108, a separator 112 located between the active-metal anode and the cathode, and a non-solid electrolyte, which is illustrated by an extent line 116, extending in this example from the cathode 108 to a nonporous second composite layer 124 (see below), that illustrates that the non-solid electrolyte is in contact with both the cathode and the second composite layer. The active-metal anode 104 includes at least one active-metal layer 104AM composed of an active metal either in its elemental state or in an alloy with one or more other metals, with example active-metals listed above. Fundamentally, however, there is no limitation on the active metal other than it have the propensity to form dendrites/mossy metal during cycling of the active-metal cell.

In this example, the active-metal anode 104 also includes a current collector 104CC, which may be any suitable type of current collector, such as, for example, a copper current collector, or a nickel current collector or a titanium current collector, any of which can be a continuous sheet or an apertured structure, such as a perforated sheet or an expanded mesh, among others. While the example of FIG. 1A shows the active-metal anode 104 having the active-metal layer 104AM only on one side of the current collector 104CC, in other embodiments, the active-metal anode may have active-metal layers on both sides of the current collector. In some embodiments, the active-metal layer 104AM may not be present until the initial charging of the active-metal cell if the active-metal cell is of the type that is constructed with the current collector 104CC bare and uses the first charging cycle to plate the bare current collector. In many embodiments, though, the active-metal anode 104 will be constructed with the active-metal layer 104AM having a non-zero thickness.

The cathode 108 may be any suitable cathode compatible with the active material and the non-solid electrolyte, such as a cathode of the intercalant type in which ions of the active material intercalate in spaces (not shown) within a cathode active layer 108AL. In an example in the context of the active metal being lithium, the cathode active material 108AL may be a lithium transition metal oxide material (e.g., LiMO₂, M=Co, Ni, Mn, etc.) mixed with conductive carbon and binder, and slurry coated on an aluminum current collector foil. In this embodiment, the cathode 108 also includes a current collector 108CC made of a suitable material, such as aluminum or copper, among others. As those skilled in the art will appreciate, the cathode 108 can be designed and constructed by someone of ordinary skill in the art, and the particular type of the cathode is not critical to the understanding of primary dendrite-growth-suppression features of the present disclosure and their corresponding functionalities. Therefore, it is not necessary to provide an exhaustive description of the cathode 108 for those skilled in the art to understand and practice the primary aspects of this disclosure to their fullest scope without undue experimentation.

The separator 112 may be a porous separator that provides conventional separator functionality, namely, provides a dielectric layer that electrically separates the active-metal anode 104, and anode side of the active-metal cell generally, from the cathode 108, and the cathode side of the active-metal cell generally. During use, pores (not shown) within the separator 112 are soaked with a portion of the non-solid electrolyte 116 so that there is ionic-flow continuity, within the portion of the non-solid electrolyte permeating the separator, between the portions of the non-solid electrolyte on the anode and cathode sides of the active-metal cell. The separator 112 may be comprised of any one or more suitable dielectric materials, such as polymers (e.g., polyolefins, etc.) and/or ceramics (e.g., alumina, silica, etc.) in any suitable configuration. As with the cathode 108, the particular configuration of the separator 112 is not critical to the understanding of primary aspects of the present disclosure, namely, the dendrite-growth-suppression features and their respective functionalities. Therefore, it is not necessary to provide an exhaustive description of the separator 112 for those skilled in the art to understand and practice the primary aspects of this disclosure to their fullest scope without undue experimentation.

In the embodiment shown, the internal components further include a first composite layer 120 located between the active-metal anode 104 and the separator 112. The first composite layer 120 is designed, configured, and provided to scavenge and trap any dendrites (such as the dendrite 104D illustrated in the inset of FIG. 1A) that may grow from the active-metal anode 104 to prevent it/them, if it/they were to grow large enough, from penetrating through the first composite layer. Preventing dendrites from penetrating the first composite layer 120 keeps them from penetrating into and through the separator 112 and to the cathode 108 and, consequently, prevents the dendrite(s) from causing an electrical short-circuit between the active-metal anode and the cathode 108.

In this example, the first composite layer 120 comprises a porous matrix 120PM having pores 120P (illustrated functionally within the inset of FIG. 1A; only a few labeled to avoid clutter) that allow the non-solid electrolyte 116 to saturate the composite matrix and allow ions of the active metal within the non-solid electrolyte to flow through the first composite layer. At least some of the pores 120P of the porous matrix 120PM (only a couple of regions labeled to avoid clutter) are at least partially filled with an alloying material 120AM that is selected for its ability to spontaneously alloy with the active metal within the dendrite(s) that grow into contact with the alloying material. In some embodiments, the porosity of the porous matrix 120PM may be in a range of about 20% to about 85%, in a range of about 30% to about 80%, or in a range of about 50% to about 70%, among others. In some embodiments, the size of the pores 120P of the porous matrix 120PM may be in a range of about 20 nm to about 5 μm, in a range of about 40 nm to about 3 μm, or in a range of about 50 nm to about 1 μm, among others. In some embodiments, the overall thickness of the porous matrix 120PM may be in a range of about 2 μm to about 20 μm, in a range of about 3 μm to about 10 μm, or in a range of about 4 μm to about 6 μm, among others. The porous matrix 120PM may be made of any suitable material, such as a polyolefin (e.g., polyethylene (PE), polypropylene (PP), etc.), polyvinylidene fluoride (PVDF), polytetrafluoroethylene (PTFE), polyvinyl chloride (PVC), cellulose, rubber, and glass, among others, and any suitable combination thereof.

In some embodiments, the alloying material 120AM only partially fills the pores 120P to leave the pores partially open so that the non-solid electrolyte 116 can saturate the first composite layer 120, and ions of the active metal within the non-solid electrolyte can flow through the first composite layer when no dendrite(s) is/are present in the first composite layer. In some embodiments, the amount of alloying material added to the porous matrix 120PM is added in an amount that does not significantly impact the porosity of the porous matrix so as to not interfere with ion conductivity through the first composite layer 120. For example, in some embodiments, the porosity of the porous matrix 120PM is reduced by less than about 20%, less than about 10%, or less than about 5%, among others, by the addition of the alloying material 120AM. The alloying material 120AM may be provided, for example, in any suitable form, such as sub-micron to nanometer-sized particles. The alloying material 120AM may include any one or more materials that readily and spontaneously alloy with the active metal of the active-metal layer 104AM of the active-metal anode 104. In the case of the active metal being lithium, such alloying materials include, but are not limited to, silver, indium, aluminum, magnesium, tin, silicon, and graphitic carbon, any or all of which can be provided in particle form.

When an alloying material is provided in particle form, in some embodiments the particles may have a diameter or maximum dimension in a range of about 1 nm to about 1000 nm, a range of about 5 nm to about 300 nm, or a range of about 10 nm to about 100 nm, among other sizes. In some embodiments, the alloying material 120AM is provided in a range of about 1 weight-percent (wt %) to about 50 wt %, a range of about 1 wt % to about 30 wt %, a range of about 1 wt % to about 20 wt %, or about 5 wt % to about 10 wt %, all relative to the total weight of the finished first composite layer 120. In some embodiments, the alloying material 120AM in the first composite layer 120 may be provided in a weight-percent amount relative to the overall weight of the first composite layer in a range of about 1% to about 5%, about 5% to about 10%, about 10% to about 15%, about 15% to about 20%, about 20% to about 25%, about 25% to about 30%, about 30% to about 35%, or any combination of two or more of these ranges. In some embodiments, the alloying material 120AM will typically be distributed evenly in the pores 120P of the porous matrix 120PM and will not form a continuous electrically conductive path across the thickness of the first composite layer 120. In some embodiments, the distribution of alloying material 120AM may be biased toward the side of the first composite layer 120 that faces toward the active-metal anode 104. In an example, when the alloying material 120AM is provided as particles, these particles can be incorporated into the porous structure of the porous matrix 120PM by dispersing the particles in a solvent medium that infiltrates the pores 120P and then removing the solvent medium. In another example in which the porous matrix 120PM comprises a polymer, particles of the alloying material 120AM can be added during extrusion to the initial molten polymer. That said, the alloying material 120AM can be added to the porous matrix 120PM in any suitable manner.

In some embodiments, the first composite layer 120 may include solid electrolyte particles (not labeled) dispersed within the porous matrix 120PM. In some embodiments, the solid electrolyte particles may be provided to the first composite layer 120 in an amount in a range of about 5 wt % to about 50 wt % or about 10 wt % to about 30 wt % relative to the weight of the first composite layer, among others. In some embodiments, the solid electrolyte particles in the first composite layer 120 may be provided in a weight-percent amount relative to the overall weight of the first composite layer in a range of about 5% to about 10%, about 10% to about 15%, about 15% to about 20%, about 20% to about 25%, about 25% to about 30%, about 30% to about 35%, about 35% to about 40%, about 40% to about 45%, about 45% to about 50%, or any combination of two or more of these ranges. In some embodiments in which the active-metal comprises lithium, the solid electrolyte particles may comprise Al-doped LLZO (Li_{6.25}Al_{0.25}La₃Zr₂O₁₂) garnet oxide having high room temperature Li⁺ conductivity (e.g., in the range of 10⁻³ S/cm), perovskite (Li_{0.29}La_{0.57}TiO₃), LISICON (Li₁₄ZnGe₄O₁₆), NASICION (Li_{1.3}Al_{0.3}Ti_{1.7}(PO₄)₃), thio-LISICON (Li₁₀GeP₂S₁₂), and other glass (e.g., lithium phosphorus oxynitride (LiPON)) and glass-ceramic (70Li₂S·30P₂S₅) type materials and suitable mixtures of any of the foregoing materials, among others. Those skilled in the art will be able to select the composition of the solid electrolyte particles for active metals other than lithium.

In some embodiments, the size of the solid electrolyte particles may be in a range of about 50 nm to about 2000 nm or in a range of about 500 nm to about 1500 nm. In some embodiments, the size of the solid electrolyte particles may be in a range of about 50 nm to about 250 nm, about 250 nm to about 500 nm, about 500 nm to about 750 nm, about 750 nm to about 1000 nm, about 1000 nm to about 1250 nm, about 1250 nm to about 1500 nm, about 1500 nm to about 1750 nm, or about 1750 nm to about 2000 nm, or any combination of two or more of these ranges. The solid electrolyte particles may be incorporated directly in the material of the porous matrix 120PM. In an example, when the porous matrix 120PM is composed of a polyolefin, the porous matrix may be made by a wet or dry process. In a dry process example, a molten mixture of polyolefin and solid electrolyte particles may be first extruded into thin sheets, which are then bi-axially stretched to produce the porous matrix 120PM. In a wet process example, a plasticizer may be first added to the molten mixture and extruded into thin sheets, from which the plasticizer is extracted-out to create the pores 120P of the porous matrix 120PM.

TABLE I

| | Weight |
|---|---|
| Composition | (% of total) |
| Polyolefin (PE or PP) | 75 |
| Ag nano-particles (30 to 50 nm) | 5 |
| Al-doped Li_{6.25}AL_{0.25}La₃Zr₂O₁₂ (D₅₀ = 500 nm) | 20 |

As a nonlimiting illustration of the first composite layer 120, Table I, above, shows an example composition of the first composite layer 120 and the corresponding weight percentages of the components relative to the entire first composite layer. Sheets of the first composite layer 120 may be slit and assembled into the internal components of the active-metal cell as shown in FIG. 1, and the remaining pore space within the first composite layer may then be filled with the non-solid electrolyte 116 during the cell build.

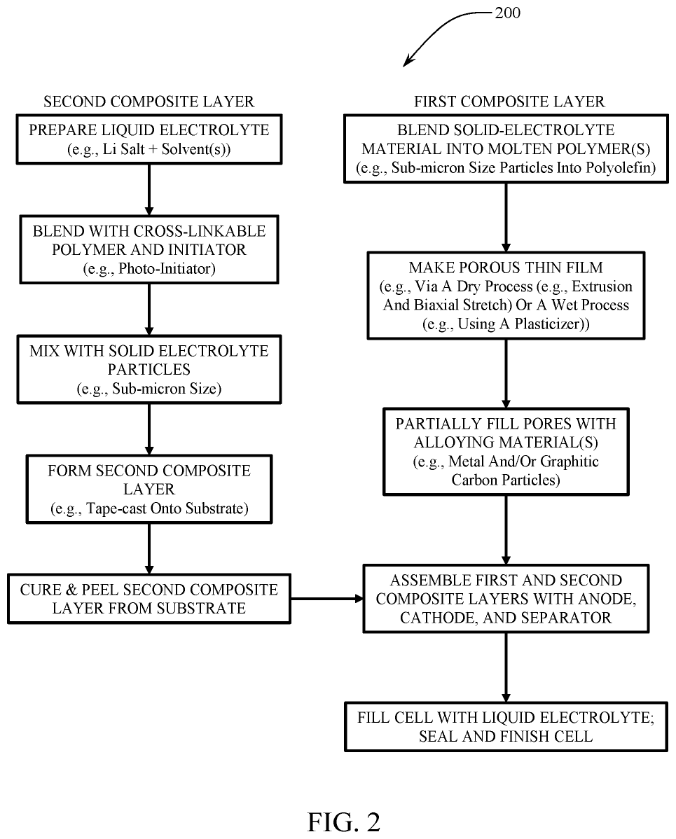

FIG. 2 shows an example flow chart 200 that includes an example method of preparing and assembling a first composite layer, such as the first composite layer 120 of FIG. 1, into an active-metal battery, here, a lithium metal battery (not shown). The first composite layer 120 can be incorporated in a battery via several different ways. For example, it can be a discrete free-standing layer that is stacked along with other layers in a cell of the battery, it can be coated directly onto a separator (e.g., separator 112 of FIG. 1), or can be coated on or bonded to an optional second composite layer, such as the second composite layer 124 of FIG. 1 (see below) prior to stacking, among others.

The first composite layer 120 of FIG. 1 is specifically designed to scavenge and trap any active-metal dendrite that may potentially penetrate the separator 112 and cause an internal short in the cell. As an active-metal dendrite grows through the pores 120P of the first composite layer 120, the tip of the dendrite will encounter the alloying material 120AM, which on contact with the dendrite will alloy with the dendrite and undergo volume expansion that consequently blocks one or more of the pores 120P. Any section of the dendrite that comes in contact with the first composite layer 120 will be consumed and broken apart by the alloying material 120AM and/or graphitic particles in the porous matrix 120PM. In addition, the solid electrolyte particles in the porous matrix 120PM can provide the necessary mechanical barrier to hinder dendrite penetration under pressure.

In some embodiments, the internal components 100 may optionally include a second composite layer 124 that comprises solid electrolyte particles and a gel electrolyte. The second composite layer 124 may be designed and configured to block direct contact between the non-solid electrolyte 116 and the active-metal anode 104, thereby acting as an interfacial layer that provides a uniform electrical current distribution on the surface of the active-metal anode 104, thereby facilitating a dense and even deposition and stripping of the active metal on the active-metal anode.

In some embodiments in which the active-metal comprises lithium, the solid electrolyte particles of the second composite layer 124 may comprise Al-doped LLZO garnet oxide having high room temperature Li⁺ conductivity (e.g., in the range of 10⁻³ S/cm), perovskite, LISICON, NASICION, thio-LISICON, and other glass (e.g., LiPON) and glass-ceramic type materials and suitable mixtures of any of the foregoing materials, among others. Those skilled in the art will be able to select the composition of the solid electrolyte particles for active metals other than lithium. In some embodiments, the size of the solid electrolyte particles may be in a range of about 50 nm to about 2000 nm or in a range of about 500 nm to about 1500 nm. In some embodiments, the size of the solid electrolyte particles may be in a range of about 50 nm to about 250 nm, about 250 nm to about 500 nm, about 500 nm to about 750 nm, about 750 nm to about 1000 nm, about 1000 nm to about 1250 nm, about 1250 nm to about 1500 nm, about 1500 nm to about 1750 nm, or about 1750 nm to about 2000 nm, or any combination of two or more of these ranges.

The solid electrolyte particles may be dispersed into the gel electrolyte of the second composite layer 124, which may be made, for example, of one or more ultraviolet light (UV) curable polymers (e.g., UV cross-linkable polymers, such as PU (poly urethane acrylate) and PEGDMA (poly ethylene glycol dimethacrylate)) and one or more active-metal-ion (e.g., Lit) conducting liquid electrolytes. Other cross-linkable polymers that may be used in the gel electrolyte include PEO (poly ethylene oxide), PPO (poly propylene oxide), PAN (poly acrylonitrile), PMMA (poly methyl methacrylate), PVC, PVDF, PVDF-HFP (poly vinylidene fluoride-hexafluoropropylene) and their mixtures, among others. In some embodiments, one or more single lithium-ion-conducting polymers, such as LiPSS (lithium poly(4-styrenesulfonate)), can be added or used to provide improved or better ionic conductivity. Examples of liquid electrolytes for the gel electrolyte of the second composite layer 124 in the context of the active metal including lithium, Litconducting liquid electrolytes can be made by dissolving one or more lithium salts, such as LiPF₆ and/or LiFSI, in an anhydrous solvent or solvent mixtures, such as a carbonate and/or an ether solvent, among many others. Those skilled in the art will understand how to select appropriate materials for the polymer and liquid electrolyte for the gel electrolyte of the second composite layer 124 such that exhaustive recitations of examples are not necessary for those skilled in the art to practice the subject matter of the present disclosure to its fullest scope.

In some embodiments, the solid electrolyte particles in the second composite layer 124 may be provided in an amount in a range of about 10 wt % to about 70 wt %, in a range of about 30 wt % to about 50 wt % or in a range of about 10 wt % to about 90 wt %, relative to the overall weight of the second composite layer, among others. In some embodiments, the solid electrolyte particles in the second composite layer 124 may be provided in a weight-percent amount relative to the overall weight of the second composite layer in a range of about 85% to about 90%, about 75% to about 85%, about 65% to about 75%, about 55% to about 65%, about 45% to about 55%, about 35% to about 45%, about 25% to about 35%, about 15% to about 25%, or about 5% to about 15%, or any combination of two or more of these ranges. In some embodiments, the thickness of the second composite layer may be in a range of about 1 μm to about 20 μm or about 2 μm to about 6 μm, among others. It is noted that if gel electrolyte is used as the non-solid electrolyte 116, it may be formulated in a manner similar to the gel electrolyte of the second composite layer 124.

TABLE II

| | Weight |
|---|---|
| Composition | (% of total) |
| PU (polyurethane acrylate) | 5 |
| PEGDMA (polyethylene glycol dimethacrylate) | 1 |
| Liquid Electrolytes (2M LiFSI in DEE:TFE 6:4 vol %) | 52 |
| Additional Salts (LiFSI) | 1.5 |
| Initiator (benzoin ethyl ether) | 0.5 |
| Al-doped Li_{6.25}AL_{0.25}La₃Zr₂O₁₂ (D₅₀ = 500 nm) | 40 |

Table II, above, shows an example composition of the second composite layer 124 and the corresponding weight percentages of the components relative to the overall second composite layer. Referring again to FIG. 2, the flow chart 200 illustrates an example preparation and assembly of the second composite layer 124 in the context of a lithium metal battery. The second composite layer may be made by mixing a slurry, tape-casting the slurry onto a glass or PTFE substrate, and curing under a UV lamp. The formed film, i.e., the second composite layer 124, may then be peeled off from the substrate and incorporated into a battery, for example, within the internal components 100 of a cell of a battery as shown in FIG. 1. The second composite layer 124 can be incorporated into a battery cell in any of several different ways. For example, it can be a discrete free-standing layer that is stacked along with other layers in a cell, it can be coated directly onto the active-metal anode 104, or can be coated onto or bonded to the first composite layer 120 prior to stacking, among others.

In some embodiments, the second composite layer 124 is basically designed and provided to reduce a direct reaction between the electro-deposited active metal on the active-metal anode 104 and the liquid electrolyte 116 and thereby diminish both the lithium and electrolyte losses in the cell on repeated cycling. The second composite layer 124 also provides a uniform current distribution on the surface of the active-metal anode 104, thereby facilitating dense and even depositing and stripping of the active metal on the active-metal anode. The combination of both solid-particle and gel electrolytes provides a robust mechanical barrier that hinders dendrite penetration without much compromise in the overall conductivity of the layer.

When the first and second composite layers 120 and 124 (FIG. 1) are provided together, they provide functionalities complementary to one another. The second composite layer 124 helps to reduce the formation of dendritic or mossy active metal on the active-metal anode 104 by facilitating a uniform active-metal deposition and stripping, and the first composite layer 120 helps to thwart the progress of any dendritic growth through the porous matrix 120PM of the first composite layer 120. The solid electrolyte particles dispersed in both the layers provide the mechanical barrier against lithium dendrite penetration, without compromising the active-metal conductivity. In some embodiments, the second composite layer 124 can be provided without providing the first composite layer 120.

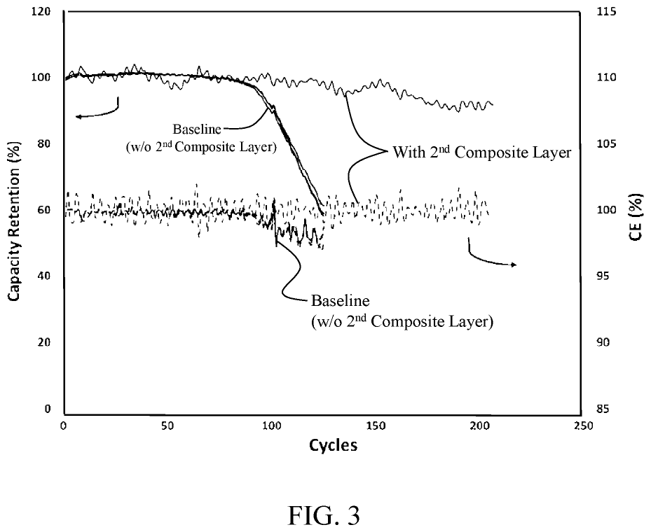

FIG. 3 shows the cycle life performance of test cells, one of which included an instantiation of the second composite layer 124 (FIG. 1) coated onto the active-metal anode (see, e.g., the active-metal anode 104 of FIG. 1) and one of which did not include such layer (the “Baseline” cell). The second composite layer in this instantiation had the composition detailed in Table II, above. Cycle life was tested using coin cells built using nickel-manganese-cobalt (NMC) cathodes, lithium-metal anodes, and microporous polyolefin-based separators. During testing, the cells were cycled between 3V to 4.3V at a C/3-C/3 charge-discharge rate. The cycle life performance of the cell with the second composite layer was found to be twice as high as the baseline cell without the second composite layer.

As noted above, the protective layers discussed above can also be used to prevent dendrite formation and penetration in other battery chemistries that undergo metallic deposition and stripping on the anode such as a sodium, potassium, aluminum, or zinc anode.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An electrochemical cell, comprising:
an active-metal anode that includes a current collector and an active metal electrically coupled to the current collector;
a cathode located in operative relation to the active-metal anode;
a separator located between the active-metal anode and the cathode;
a non-solid electrolyte in operative ionic contact with the cathode and permeating the separator;
a first composite layer located between the active-metal anode and the separator and comprising:
a porous matrix that is porous to the non-solid electrolyte and includes pores;
first solid-electrolyte particles dispersed in the porous matrix, wherein the first solid-electrolyte particles are provided to conduct ions of the active metal during operation of the electrochemical cell; and
alloying particles located in the pores of the porous matrix, wherein the alloying particles are particles selected for ability to alloy spontaneously with the active metal and deployed to inhibit dendrite growth through the first composite layer by alloying with dendrites that encounter the first composite layer.

2. The electrochemical cell of claim 1, wherein the first solid-electrolyte particles are present in an amount in a range of about 5% to about 50% by weight of the first composite layer.

3. The electrochemical cell of claim 2, wherein the first solid-electrolyte particles are present in an amount in a range of about 10% to about 30% by weight of the first composite layer.

4. The electrochemical cell of claim 1, wherein the porous matrix has a porosity in a range of about 30% to about 80%.

5. The electrochemical cell of claim 4, wherein the porous matrix has a porosity in a range of about 50% to about 70%.

6. The electrochemical cell of claim 1, wherein the pores of the porous matrix have sizes in a range of about 50 nm to about 1 μm.

7. The electrochemical cell of claim 1, wherein the alloying particles are present in an amount in a range of about 1% to about 20% by weight of the first composite layer.

8. The electrochemical cell of claim 1, wherein the alloying particles are present in an amount in a range of about 5% to about 10% by weight of the first composite layer.

9. The electrochemical cell of claim 1, wherein the porous matrix comprises one or more polymers.

10. The electrochemical cell of claim 9, wherein the porous matrix comprises a polyolefin.

11. The electrochemical cell of claim 1, wherein:
the first solid-electrolyte particles are present in an amount in a range of about 5% to about 50% by weight of the first composite layer;
the first composite layer has a porosity in a range of about 30% to about 80%; and
the alloying particles are present in an amount in a range of about 1% to about 20% by weight of the first composite layer.

12. The electrochemical cell of claim 11, wherein the pores of the first composite layer have sizes in a range of about 50 nm to about 1 μm.

13. The electrochemical cell of claim 1, wherein:
the first solid-electrolyte particles are present in an amount in a range of about 10% to about 30% by weight of the first composite layer;
the first composite layer has a porosity in a range of about 50% to about 70%; and
the alloying particles are present in an amount in a range of about 5% to about 10% by weight of the first composite layer.

14. The electrochemical cell of claim 13, wherein the pores of the first composite layer have sizes in a range of about 50 nm to about 1 μm.

15. The electrochemical cell of claim 1, further comprising a second composite layer located adjacent to the active-metal anode and between the active-metal anode and the first composite layer, the second composite layer comprising second solid electrolyte-particles dispersed in a polymer gel electrolyte, wherein the second composite layer is provided to conduct ions of the active metal during operation of the electrochemical cell.

16. The electrochemical cell of claim 15, wherein the second composite layer is nonporous so as to prevent the non-solid electrolyte solution from contacting the active-metal anode.

17. The electrochemical cell of claim 16, wherein the active metal comprises lithium metal.

18. The electrochemical cell of claim 15, wherein the second solid-electrolyte particles are present in a range of about 10% to about 70% by weight of the second composite layer.

19. The electrochemical cell of claim 18, wherein:
the first solid-electrolyte particles are present in an amount in a range of about 5% to about 50% by weight of the first composite layer;
the first composite layer has a porosity in a range of about 30% to about 80%; and
the alloying particles are present in an amount in a range of about 1% to about 20% by weight of the first composite layer.

20. The electrochemical cell of claim 19, wherein the pores of the first composite layer have sizes in a range of about 50 nm to about 1 μm.

21. An electrochemical cell, comprising:
an active-metal anode that includes a current collector and an active metal electrically coupled to the current collector;
a cathode located in operative relation to the active-metal anode;
a non-solid electrolyte in operative ionic contact with the cathode;
a composite layer located between the active metal of the active-metal anode and the non-solid electrolyte, wherein the composite layer is provided to inhibit dendrite growth on the active-metal anode and to function as an active-metal-ion conductor between the active metal and the non-solid electrolyte and comprises:
a polymer gel electrolyte containing at least one polymer and a liquid electrolyte; and
solid-electrolyte particles dispersed in the polymer gel electrolyte, wherein the solid-electrolyte particles are provided to conduct ions of the active metal during operation of the electrochemical cell.

22. The electrochemical cell of claim 21, wherein the active metal comprises lithium and each of the non-solid electrolyte, the solid electrolyte particles, and the liquid electrolyte comprise lithium ions.

23. The electrochemical cell of claim 21, wherein the at least one polymer contains the active metal.

24. The electrochemical cell of claim 23, wherein the active metal comprises lithium and the at least one polymer contains lithium.

25. The electrochemical cell of claim 21, wherein the composite layer is nonporous so as to prevent the non-solid electrolyte solution from contacting the active-metal anode.

26. The electrochemical cell of claim 21, wherein the composite layer has an overall weight, and the solid-electrolyte particles are present in the composite layer in a weight-percent range of about 10% to about 90% relative to the overall weight.

27. The electrochemical cell of claim 21, wherein the composite layer has an overall weight, and the solid-electrolyte particles are present in the composite layer in a weight-percent range of about 40% to about 90% relative to the overall weight.

28. The electrochemical cell of claim 21, wherein the composite layer has an overall weight, and the solid-electrolyte particles are present in the composite layer in a weight-percent range of about 60% to about 90% relative to the overall weight.

29. The electrochemical cell of claim 21, wherein the composite layer has an overall weight, and the solid-electrolyte particles are present in the composite layer in a weight-percent range of about 70% to about 90% relative to the overall weight.

30. The electrochemical cell of claim 21, wherein the solid electrolyte particles have a size in a range of about 50 nm to about 2000 nm.

31. The electrochemical cell of claim 30, wherein the size is in a range of about 500 nm to about 1500 nm.

32. The electrochemical cell of claim 21, wherein the composite layer is in physical contact with the active metal of the active-metal anode.

33. (canceled)
